(19) United States
(12) Patent Application Publication
(10) Pub. No.: US 2007/0041737 A1
(43) Pub. Date: Feb. 22, 2007

(54) Method for the control of a transport medium and a sensor device for a printing machine

(76) Inventors: Holger Runkowske, Probsteierhagen (DE); Uwe Hoffmann, Kiel (DE)

Correspondence Address: David A. Novais;Patent Legal Staff, Eastman Kodak Company, 343 State Street, Rochester, NY, 14650-2201, US

(21) Appl. No.: 11/528,060

(22) Filed: Sep. 27, 2006

(30) Foreign Application Priority Data
Mar. 27, 2004 (DE) 102004015101.6
Mar. 8, 2005 (WO) PCT/EP05/03091

(51) Int. Cl. G03G 15/00

(52) U.S. Cl. 399/16

(57) ABSTRACT

An object of the invention is to determine the position of a transport medium in a printing machine in a simple manner. Provided is a method for the control of a transport medium for a printing machine, whereby at least one mark is applied to the transport medium and whereby a single sensor detects a seam of the transport medium, as well as the mark. Also provided is a sensor device for the control of a transport medium for a printing machine, said device comprising a sensor for the detection of a seam of a transport medium and at least one mark on said transport medium.

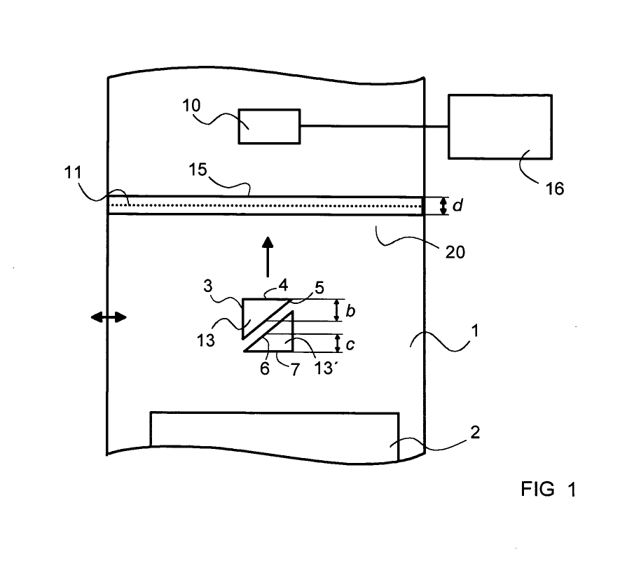

The invention relates to a method in accordance with the preamble of claim 1 and to a sensor device in accordance with the preamble of claim 11.

In the printing industry, the transport of paper sheets is usually performed by driven transport belts which transport the sheet of paper or the printing material through the printing machine. In so doing, an important criterion is that the transport belt, more generally the transport medium, retains its position and that its deviations are as minimal as possible. Deviations of the position of the transport medium in advance direction or perpendicular to advance direction of the transport medium result in misprints on the printing material transported by the transport medium. For this purpose, marks are sometimes used, these marks being printed on the transport medium and allowing the determination of the position of the transport medium. Frequently, these marks are described as register marks or guide marks. Deviations from the desired positions of the transport medium can be determined with the aid of these marks. The deviation of the mark on the transport medium allows a conclusion as to the corresponding deviation of the transport medium from its error-free ideal position. The present patent application makes reference to and includes German Patent Application DE 101 319 57, in which the registering accuracy of a printed image, in particular viewed in the direction perpendicular to the direction of movement in the transport plane, is determined with the aid of a register mark detected by a sensor.

An object of the invention is to determine the position of a transport medium in a printing machine in a simple manner.

This object is achieved with the features of claims 1 and 11.

Embodiments of the invention are disclosed in the subclaims.

Following, the invention is described in detail, as an example, with reference to an embodiment as shown by the FIGURE.

The FIGURE shows a schematic plan view of a section of a transport medium 1 in a printing machine. Transport medium 1, for example, is a continuous transparent transport belt, which is stretched around deflecting rollers in the printing machine and which is used as support for transporting a printing material 2. Transport medium 1 is well-known and so are printing machines, which apply printed images to a printing material 2 with the aid of automatically adjustable registering accuracy or alignment, in particular, so-called digital printing machines such as a printing machine that works on the principle of photoelectricity. Transport medium 1 has a seam 11 at a location which extends from one side to the opposite side of transport medium 1 and at which transport medium 1 is joined, in particular glued together. For example, a continuous transport belt is joined at seam 11. Transport medium 1 is moved in the direction indicated by the one-sided arrow. Printed on transport medium 1 is a mark 3 which is used to detect the position of transport medium 1. Mark 3 is permanently applied to, preferably printed on, transport medium 1. Other methods of application may be implemented. It should be noted that mark 3 is not printed by printing units or printing modules of the printing machine, but is already present on transport medium 1 before the printing operation or calibrating operation of the printing machine and is preferably applied during the manufacture of transport medium 1. Mark 3 consists of two opposing identical equal-sided right triangles 13, 13′, i.e., the first triangle 13 and the second triangle 13′, with their hypotenuses facing each other and a gap being created between said triangles, i.e., the two triangles 13, 13′ are at a specific distance from each other as shown by the FIGURE. A sensor 10 is arranged above transport medium 1, said sensor being connected with a control device 16 of the printing machine. Control device 16 receives the appropriate signals from sensor 10 and converts them into distances. To achieve this, the required parameters, in particular the velocity of transport medium 1, are known in control device 16. Preferably, sensor 10 is arranged in front of the printing units or printing modules of the printing machine, close to the beginning of the transport path of printing material 2. In one modification, sensor 10 detects seam 11, at which transport medium 1 is joined for transporting printing material 2, and transfers a corresponding signal to control device 16. In the embodiment of the FIGURE, seam 11 is covered by a strip 15 which, in this case, covers seam 11 along its entire length; however, strip 15 may be designed in a shorter manner and then cover only a section of seam 11. In the FIGURE, seam 11 is indicated by dotted lines to make it visible, however, strip 15 is not transparent, and hence seam 11 is not visible in this plan view. Strip 15 is in high contrast to transport medium 1 and is preferably applied by being glued to or printed on transport medium 1. In this example, sensor 10 detects strip 15 on transport medium 1, instead of seam 11. Strip 15 is considerably easier for sensor 10 to detect than the thin, difficult-to-detect seam 11. Preferably, strip 15, which is shown wide here for better understanding, is detected across its entire width d; furthermore, an edge of strip 15 may be detected by sensor 10. Inasmuch as strip 15 is wide compared with seam 11, a sensor 10 exhibiting lower resolving power may be used in this embodiment. Seam 11 is detected by sensor 10 during each rotation about the deflecting rollers. The distance between one detection of seam 11 and the next detection of said seam is determined by control device 16, and is compared with a stored predetermined distance. If the determined distance, i.e., the actual distance, corresponds to the predetermined distance, the position of transport medium 1 is correct in advance direction. If the determined distance, i.e., the actual distance, does not correspond to the predetermined distance, transport medium 1 has shifted along advance direction or transport direction, and the position of transport medium 1 in advance direction is inaccurate. These shifts of transport medium 1 in transport direction are caused, for example, because transport medium 1 slips on the deflecting rollers, this being undesirable because such shifts have the effect that the printed image is printed at the wrong place on printing material 2 in transport direction. The shift of transport medium 1 is indicated by an indicating device of the printing machine, at least if the shift exceeds a specific value which results in the undesirable shift of the image lines of the printed image. Shifted image lines become particularly conspicuous in multicolor printing, when several colors are printed on top of each other to result in the complete color picture. The detected shift of transport medium 1 is corrected; either transport medium 1 is aligned, or the imaging process is adjusted accordingly and, as a result, the shift of transport medium 1 in transport direction is corrected. Specifically, this means that the imaging time of the imaging device of the printing machine is started earlier when transport medium 1 has slipped forward. As described above, this is determined because the detected time between successive detections of seam 11 or strip 15 by sensor 10 is reduced. Correspondingly, the imaging time is started later when transport medium 1 has slipped backward relative to the detection by sensor 10, and, consequently, based on the sensor signals of sensor 10, control device 16 determines a longer advance time between the detection times of seam 11 or strip 15.

If transport medium 1 moves further in the direction of the arrow, sensor 10 next detects the leading edge 4 of the first triangle 13, thus transferring a corresponding signal to control device 16. By using mark 3, which is configured of the first triangle 13 and the second triangle 13′, the position of transport medium 1 is detected in the direction about an angle of 90 degrees transverse or perpendicular to the transport direction in the transport plane—the so-called cross-track—as indicated by the double-sided arrow in the FIGURE. To achieve this, the distance b between the leading edge 4 of the first triangle 13 and the trailing edge 5 of the first triangle 13 is determined. In so doing, the leading edge 4 of the first triangle 13 is a leg of the first triangle 13, while the trailing edge 5 of the first triangle 13 is the hypotenuse of the first triangle 13. In addition, the distance c from the leading edge 6 of the second triangle 13′ to the trailing edge 7 of the second triangle 13′ is determined. In so doing, the leading edge 6 of the second triangle 13′ is a hypotenuse of the second triangle 13′, while the trailing edge 7 of the second triangle 13′ is a leg of the second triangle 13′. As a result of these two distances b and c, a potential shifting of mark 3 on transport medium 1 in a direction perpendicular to the transport direction in the transport plane—the cross-track—and the resultant corresponding shift of transport medium 1 can be determined. If transport medium 1 is in an incorrect position, in view of its position perpendicular to its advance direction in the transport plane, distances b and c of mark 3 will change. If mark 3 is shifted to the left in the FIGURE, distance b becomes smaller while distance c becomes greater. If mark 3 is shifted to the right in the FIGURE, due to a corresponding shift of transport medium 1 which carries printing material 2 with mark 3, distance b becomes greater while distance c becomes smaller. In control device 16, each distance combination b and c is associated in an unambiguous manner with a position error of transport medium 1 perpendicular to the transport direction, said position error, for example, being assigned to a cross-reference list or look-up table in control device 16. Thus, the combination of the measured lengths b and c results in a corresponding length value of the shift of transport medium 1. This length value is corrected in order to avoid a corresponding shift of the printed image on printing material 2, perpendicular to the transport direction of transport medium 1. As an example, a deflecting roller, on which transport medium 1—in this case a transport belt—is stretched, is pivoted by a device about a path in such a manner that transport medium 1 shifts by a desired path—which corresponds to this shift—along the deflecting roller in opposite direction. In this case, the pivoting direction of the deflecting roller is usually upward, perpendicular to the transport direction. By pivoting the deflecting roller in upward direction, the position of transport medium 1 is changed and no longer follows the horizontal, thus shifting transport medium 1 into a direction opposite its determined shift. In this way, the shift of transport medium 1 perpendicular to advance direction is corrected, and transport medium 1 again resumes its correct position. Once this has been achieved, the device pivots the deflecting roller and transport medium 1 into the transport medium's original horizontal position, and transport medium 1 is not shifted further.

Once sensor 10 detects the leading edge 20 of printing material 2, sensor 10 transfers a signal to control device 16. This signal is used by control device 16 to determine the time at which imaging takes place in the printing machine. This means, the leading edge 20 of printing material 2 determines at what point in time the imaging device of the printing machine applies the printed image on printing material 2. This point in time is a specified time after the detection of the leading edge 20 of printing material 2, said specified time corresponding to a specified distance of the printed image from the leading edge 20 of printing material 2. In this manner, the printing image is transferred to printing material 2 as a function of the position of the leading edge 20 of printing material 2. Ideally, the printing image is applied in this manner at a specified distance from the leading edge 20 of printing material 2. Consequently, sensor 10, as described, fulfills three functions. Firstly, the position of transport medium 1 in its direction of movement or advance direction is determined via a seam 11 or a strip 15; secondly, the position of transport medium 1 perpendicular to its advance direction in the transport plane is determined by using mark 3; and, thirdly, the sensor signal, via the leading edge 20 of printing material 2, is used to derive a point in time in conjunction with the application of the printing image on printing material 2.

1. Method for the control of a transport medium (1) for a printing machine, whereby at least one mark (3) is applied to the transport medium (1), characterized in that a single sensor (10) detects a seam (11) of the transport medium (1), as well as the mark (3).

2. Method as in claim 1, characterized in that, by using the seam (11) and the mark (3) detected by the sensor (10), the position of the transport medium (1) in its direction of movement is determined.

3. Method as in claim 1 or 2, characterized in that, by using the seam (11) and the mark (3) detected by the sensor (10), a deviation of the transport medium (1) from its direction of movement is determined.

4. Method as in one of the previous claims, characterized in that, by using the mark (3), a deviation of the transport medium (1) in the direction perpendicular to its direction of movement in the transport plane is determined.

5. Method as in one of the previous claims, characterized in that the sensor (10) detects an edge of the printing material (2) and the resultant sensor signal triggers an imaging process in order to apply the printing image on the printing material (2).

6. Method as in one of the previous claims, characterized in that the seam (11) of the transport medium (1) is at least partially covered by a strip (15), and that the sensor (10) detects the strip and the mark (3).

7. Method as in claim 6, characterized in that the strip (15) is glued to the transport medium (1).

8. Method as in claim 6, characterized in that the strip (15) is printed on the transport medium (1).

9. Method as in one of the previous claims, characterized in that a shift of the transport medium (1) in transport direction is corrected by changing the point in time when imaging occurs.

10. Method as in one of the previous claims, characterized in that a shift of the transport medium (1) perpendicular to the transport direction is corrected by a device for path control by pivoting a deflecting roller carrying the transport medium (1).

11. Sensor device for the control of a transport medium (1) for a printing machine, in particular for carrying out the method as in claim 1, characterized by a sensor (10) for the detection of a seam (11) of a transport medium (1) and of at least one mark (3) on the transport medium (1).

12. Sensor device as in claim 11, characterized by a strip (15) on at least one section of the seam (11) of the transport medium (1) for the detection by the sensor (10).

13. Sensor device as in claim 11 or 12, characterized by a control device (16) for the determination of the position of the transport medium (1) in its direction of movement with the use of the seam (11) or the strip (15), and in its direction perpendicular to the direction of movement of the transport medium in the transport plane with the use of the mark (3).
